(19) United States
(12) Patent Application Publication
(10) Pub. No.: US 2016/0207088 A1
(43) Pub. Date: Jul. 21, 2016

(54) APPARATUS AND METHOD OF SHEARING FOR QUALITY IMPROVEMENT FOR STEEL PLATE SHEARING EDGE

(71) Applicant: Hyundai Motor Company, Seoul (KR)

(72) Inventor: Chang-Woo Park, Yangpyeong-gun (KR)

(73) Assignee: Hyundai Motor Company, Seoul (KR)

(21) Appl. No.: 14/939,785

(22) Filed: Nov. 12, 2015

(30) Foreign Application Priority Data
Jan. 21, 2015 (KR) 10-2015-0009865

(51) Int. Cl. B21D 28/16; B23D 35/00; B23D 15/00; B23D 33/00

(52) U.S. Cl. CPC B21D 28/16; B23D 33/00; B23D 35/001; B23D 15/002

(57) ABSTRACT

The present disclosure provides a shearing method for improving the quality of a steel plate shearing edge, and a shearing apparatus to improve the quality of the steel plate shearing edge. The apparatus includes: a die; a stripper for fixing a steel plate positioned on the top of the die; a trim punch for shearing the steel plate fixed between the die and the stripper, and a finishing die for reducing an area ratio of a fracture surface of a shearing edge formed by shearing the steel plate and removing a burr. By using the apparatus, components can be prevented from being damaged and a life-span can be increased through removing a burr generated at the shearing edge of the steel plate and reducing a fracture surface ratio.

### CROSS-REFERENCE TO RELATED APPLICATION

This application claims the benefit of Korean Patent Application No. 10-2015-0009865, filed on Jan. 21, 2015, which is hereby incorporated by reference herein in its entirety.

### FIELD

The present disclosure relates to an apparatus and a method of shearing for quality improvement for a steel plate shearing edge.

### BACKGROUND

The statements in this section merely provide background information related to the present disclosure and may not constitute prior art.

In general, most machines and mechanisms are constituted by combinations of various components and metallic or non-metallic components used therein are manufactured by predetermined processing methods suitable therefor, respectively.

Herein, in the metallic components, a burr may not be generated at a sharing edge by a non-cutting process such as casting or forging, but the burr may be generated by a trim or piercing process. In an apparatus in which high precision is not required, there is no problem associated with the burr, but in an apparatus in which the high precision is required, the burr exerts a bad influence on an operation of the apparatus, and as a result, the burr needs to be removed.

As a method for removing the burr to improve the quality of the shearing edge, a method in which a worker manually removes the burr in person by using a manual tool such as a drilling tool or sandpaper was used in the related art. In particular, when an internal shape is complicated, there is a problem in that it is very difficult to mechanically design an automation facility for removing the burr, and as a result, the burr is manually removed in general.

However, the manual removal of the burr requires a lot of time and difficult to apply to mass production. Further, a scratch is frequently generated by the removal of the burr and the scratch contributes to formation of a crack, and as a result, there is a potential danger which may damage a product.

Therefore, development of a technique for preventing the burr from being generated from the trim or piercing process has been required. Korean Patent Registration No. 10-1197445 discloses a burring apparatus for manufacturing a cylindrical flange of a suspension arm and is a technique in which a punch passes through a hole to be processed with the cylindrical flange to remove the burr, and the like.

Further, Korean Patent Publication No. 10-2004-0027526 discloses a piercing method of a metallic plate. The piercing method is a technique that first performs a half blanking process of shearing the steel plate while a rib is maintained with ⅓ or more of a minimum thickness so as to semipermanently the life-spans of a mold, a die, and the like and thereafter, performs piercing processing of a position at which the half blanking process is performed to prevent the burr from being generated.

Therefore, the present disclosure provides a more effective apparatus and a more effective method for sharing a steel plate, which can reduce an area distribution of a fracture surface generated at a shearing edge of the steel plate and remove the burr, and the like.

### SUMMARY

The present disclosure provides an apparatus and a method for shearing a steel plate, which effectively can remove a fracture surface and a burr generated at a shearing edge of the steel plate by additionally using a finishing die in a shearing process of the steel plate.

In one aspect, the present disclosure provides a shearing apparatus capable of improving the quality of a steel plate shearing edge according to the present disclosure includes: a die (100); a stripper 200 for fixing a steel plate 300 positioned on the top of the die 100; and a trim punch 400 for shearing the steel plate 300 fixed between the die 100 and the stripper 200, and the apparatus further includes a finishing die 500 for reducing an area ratio of a fracture surface 353 of a shearing edge 350 formed by shearing the steel plate 300 and removing a burr 354.

Meanwhile, in another aspect, the present disclosure provides a shearing method capable of improving the quality of a steel plate shearing edge. The method includes: a first step in which a trim punch positioned on the top drops downward to shear a steel plate fixed between a die and a stripper; a second step in which the trim punch shearing the steel plate rises upward; a third step in which a finishing die positioned on the bottom rises upward to be inclined along one surface of the die to reduce an area ratio of a fracture surface generated at a shearing edge of the steel plate and remove a burr; and a fourth step in which the finishing die drops downward to be inclined.

In one form, a moving inclination angle α of the finishing die that rises to be inclined may be in the range of 25° to 35° based on a vertical line and in another form the inclination angle is approximately 30°.

Meanwhile, a material of the finishing die may be SKD11.

Further, a load of the finishing die may be in the range of approximately 15 to 22 kN.

As described above, according to the present disclosure having such a configuration, components can be prevented from being damaged and a life-span can be increased through removing a burr and reducing a fracture surface ratio and the overall qualities a steel plate and the components can be improved, such as corrosion prevention, securing a painting property, and the like through securing a finished surface, in forming the finished surface by finishing a fracture surface and a burr generated at a shearing edge of the steel plate through inclusion of a finishing die.

Further, a postprocessing process required to remove the burr in the related art can be saved and quality improvement can be achieved by more neat appearance and precision, and the burr or the like which may be generated again in a cutting process can be prevented from being formed.

Moreover, a slide structure is applied to movement of the finishing die, and as a result, the fracture surface and the burr can be removed even though finishing pressure is not high, thereby preventing the steel plate from being deformed.

In addition, one process may show an effect of multiple processes such as shaving, primary chambering, and secondary chambering by using the finishing die, and as a result, a time and cost can be reduced.

Other aspects and forms of the present disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram illustrating that a punch for shearing a steel plate drops;

FIG. 2 is a diagram illustrating that the steel plate is sheared by dropping the punch;

FIG. 3 is a diagram illustrating that a finishing die rises while the punch that drops rises;

FIG. 4 is a diagram illustrating that the finishing die that rises removes a fracture surface and a burr generated at a shearing edge of the steel plate;

FIG. 5 is a diagram illustrating the finishing die that rises drops;

FIG. 6 is a cross-sectional view illustrating a pressed surface, a shearing edge, the fracture surface, and the burr formed when the steel plate is sheared by using a trim punch; and

FIG. 7 is a cross-sectional view illustrating the burr is removed and a part of the fracture surface is replaced with a finished surface when the steel plate is sheared by using the trim punch and the finishing die is used.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particular intended application and use environment.

The present disclosure is intended to cover not only the exemplary forms, but also various alternatives, modifications, equivalents and other forms, which may be included within the spirit and scope of the present disclosure as defined by the appended claims.

Terms and words used in the present specification and claims are not to be construed as a general or dictionary meaning but are to be construed meaning and concepts meeting the technical ideas of the present disclosure based on a principle that the inventors can appropriately define the concepts of terms in order to describe their own present disclosures in best mode.

The present disclosure relates to an apparatus and a method for shearing a steel plate, which can improve the quality of a shearing edge of the steel plate using a finishing die, and the like which are used for removing a fracture surface and a burr formed the shearing edge of the steel plate sheared by a trim punch, and the like.

A shearing apparatus capable of improving the quality of a steel plate shearing edge according to the present disclosure includes: a die (100); a stripper 200 for fixing a steel plate 300 positioned on the top of the die 100; and a trim punch 400 for shearing the steel plate 300 fixed between the die 100 and the stripper 200, and the apparatus further includes a finishing die 500 for reducing an area ratio of a fracture surface 353 of a shearing edge 350 by shearing the steel plate 300 and removing a burr 354.

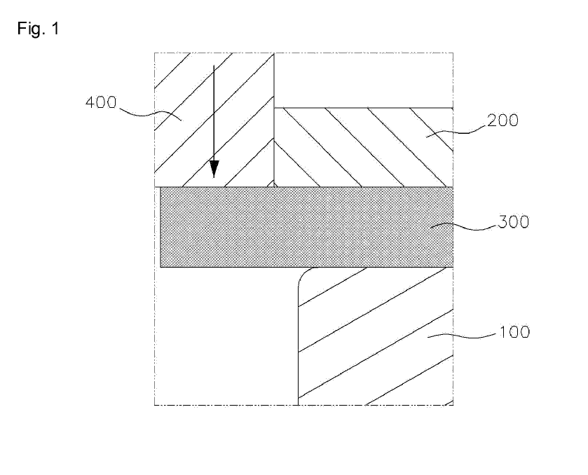

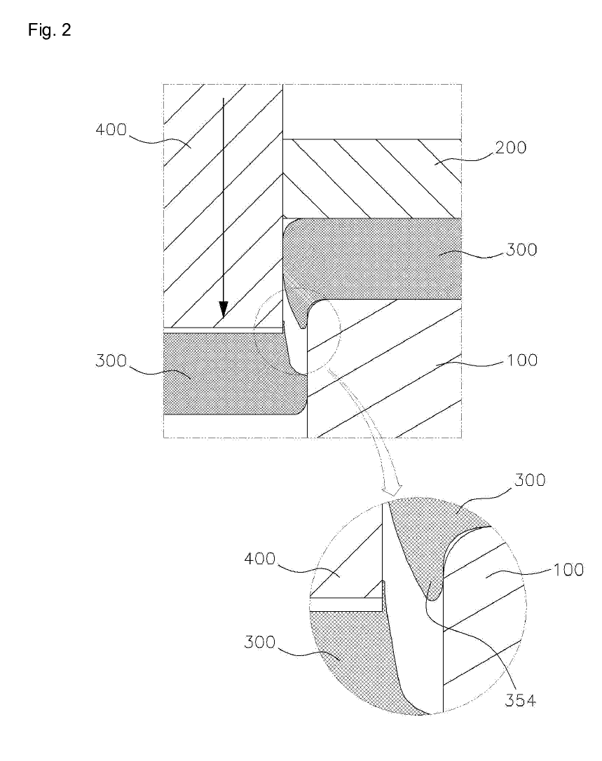

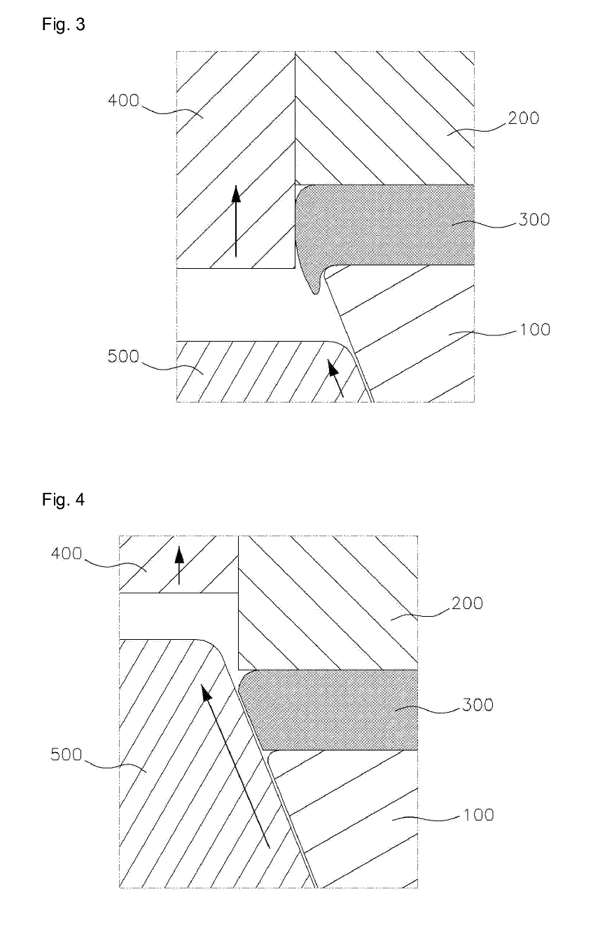

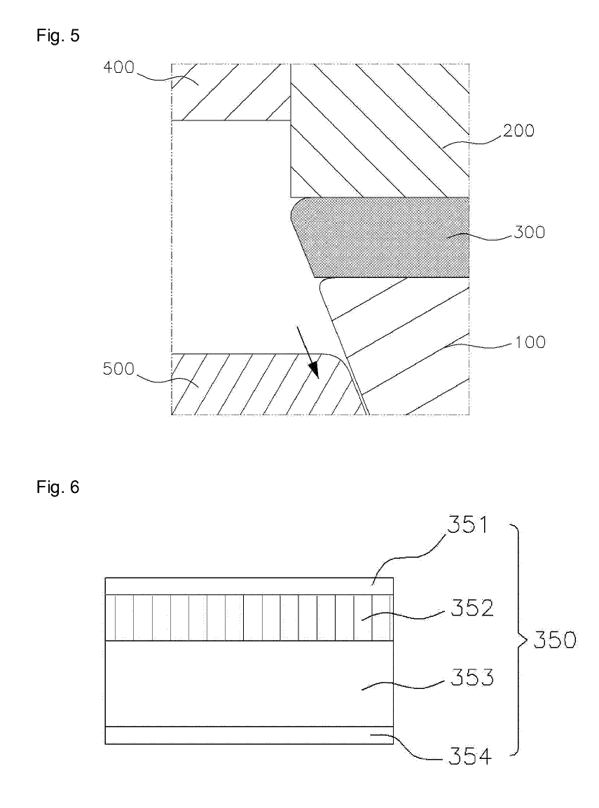

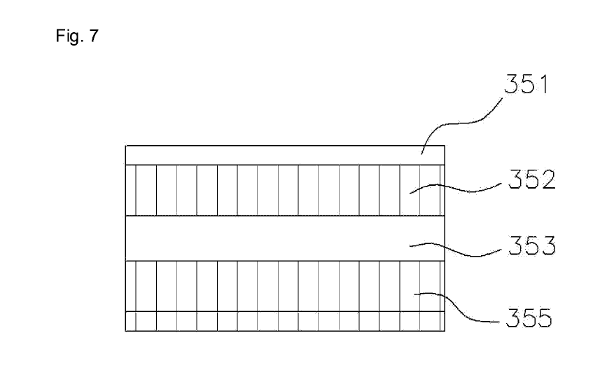

In more detail, FIG. 1 is a diagram illustrating that a punch for shearing a steel plate drops. FIG. 2 is a diagram illustrating that the steel plate is sheared by dropping the punch. FIG. 3 is a diagram illustrating that a finishing die rises while the punch rises. FIG. 4 is a diagram illustrating that the finishing die that rises removes a fracture surface and a burr generated at a shearing edge of the steel plate. FIG. 5 is a diagram illustrating the finishing die drops. FIG. 6 is a cross-sectional view illustrating a pressed surface, a shearing edge, the fracture surface, and the burr formed when the steel plate is sheared by using a trim punch. FIG. 7 is a cross-sectional view illustrating that the burr is removed and a part of the fracture surface is replaced with a finished surface when the steel plate is sheared by using the trim punch and the finishing die is used.

As illustrated in FIGS. 1 to 5, a shearing method capable of improving the quality of the steel plate shearing edge using the apparatus according to the present disclosure includes: a first step in which a trim punch 400 positioned on the top drops downward to shear a steel plate 300 fixed between a die 100 and a stripper 200; a second step in which the trim punch 400 shearing the steel plate 300 rises upward; a third step in which a finishing die 500 positioned on the bottom rises upward to be inclined along one surface of the die 100 to reduce an area ratio of a fracture surface generated at a shearing edge 350 of the steel plate 300 and remove a burr 354; and a fourth step in which the finishing die 500 drops downward to be inclined.

In more detail, a moving inclination angle α of the finishing die 500 that rises to be inclined is in the range of approximately 25 to 35° based on a vertical line and more approximately 30°. Herein, when the moving inclination angle α of the finishing die 500 is less than approximately 25° or more than approximately 30°, it may be not easy to remove reduce an area ratio of the fracture surface 353 formed at the shearing edge 350 and remove the burr 354, and the like. In particular, when the moving inclination angle α is 0°, this case is called reverse punching and it is difficult to reduce the area ratio of the fracture surface 353 or remove the burr 354, and the like by the reverse punching.

Further, as a material of the finishing die 50, even anything known in the art may be used, but SDK11 can be used in one form and vacuum heat-treated SKD11 is used in another form.

In more detail, the SKD11 is widely used general-use steel and high carbon (C) and high chromium (Cr) steel and the SKD11 may contain carbon (C) of approximately 1.4 to 1.6 W %, silicon (Si) less than approximately 0.40 W %, manganese less than approximately 0.60 W %, phosphorus (P) less than approximately 0.030 W %, sulfur less than approximately 0.030 W %, chromium (Cr) of approximately 11.0 to 13.0 W %, molybdenum (Mo) of approximately 11.0 to 13.0 W %, nickel (Ni) of approximately 0.80 to 1.20 W %, and vanadium (V) of approximately 0.20 to 0.50 W %.

Further, in the shearing edge 350 formed by shearing the steel plate 300 with the trim punch 400, a pressed surface 351, a sheared surface 352, a fracture surface 353, and a burr 354 are sequentially formed from a portion where the shearing starts as illustrated in FIG. 6. However, when the steel plate 300 is shared with the trim punch 400 and thereafter, the finishing die 500 is used as described in the present disclosure, it can be seen that the burr 354 is removed and a considerable portion of the fracture surface 353 is transformed to a finished surface 355.

Meanwhile, a load of the finishing die 500 may be in the range of approximately 15 to 22 kN. Herein, when the load of the finishing die 500 is less than approximately 15 kN, it is difficult to acquire A visual effect in reducing an area ratio of the fracture surface 353, or the like and removing the burr 354, or the like and when the load of the finishing die 500 is more than approximately 22 kN, the effect is included in reducing an area ratio of the fracture surface 353, or the like and removing the burr 354, or the like.

Herein, when the load of the finishing die 500 is equal to or more than approximately 15 kN, it can be seen that the area ratio of the finished surface 355 and when the load of the finishing die 500 is equal to or more than approximately 22 kN, it can be seen that the area ratio of the finished surface 355 does not increase any longer.

Further, the apparatus and the method for shearing which can improve the quality of the steel plate shearing edge according to the present disclosure may be applied to a piercing process using a piercing punch instead of the trim punch 400 and in this case, a finishing cone having a cone shape, and the like is used instead of the finishing die 500.

The apparatus and the method for shearing which can improve the quality of the steel plate shearing edge according to the present disclosure, which has such a feature is applied to metal processing, and the like can be applied to the shearing process or piercing process of a metallic plate.

The present disclosure has been described in detail with reference to exemplarily forms thereof. However, it will be appreciated by those skilled in the art that changes may be made in these forms without departing from the principles and spirit of the present disclosure, the scope of which is defined in the appended claims and their equivalents.

What is claimed is:

1. A shearing apparatus configured to improve a quality of a steel plate shearing edge, the apparatus comprising:
a die;
a stripper for fixing a steel plate positioned on a top of the die; and
a trim punch for shearing the steel plate fixed between the die and the stripper,
wherein the shearing apparatus further includes a finishing die configured to reduce an area ratio of a fracture surface of a shearing edge formed by shearing the steel plate and removing a burr.

2. The shearing apparatus according to claim 1, wherein the finishing die is made of a high carbon and high chromium steel.

3. The shearing apparatus according to claim 2, wherein a high carbon and high chromium steel comprises carbon (C) of approximately 1.4 to 1.6 W %, silicon (Si) less than approximately 0.40 W %, manganese less than approximately 0.60 W %, phosphorus (P) less than approximately 0.030 W %, sulfur less than approximately 0.030 W %, chromium (Cr) of approximately 11.0 to 13.0 W %, molybdenum (Mo) of approximately 11.0 to 13.0 W %, nickel (Ni) of approximately 0.80 to 1.20 W %, and vanadium (V) of approximately 0.20 to 0.50 W %.

4. A shearing method capable of improving a quality of a steel plate shearing edge, the method comprising:
a first step in which a trim punch positioned on a top drops downward to shear a steel plate fixed between a die and a stripper;
a second step in which the trim punch shearing the steel plate rises upward;
a third step in which a finishing die positioned on a bottom rises upward to be inclined along one surface of the die to reduce an area ratio of a fracture surface generated at a shearing edge of the steel plate and remove a burr; and
a fourth step in which the finishing die drops downward to be inclined.

5. The shearing method according to claim 4, wherein a moving inclination angle α of the finishing die that rises to be inclined is in a range of approximately 25° to 35° based on a vertical line.

6. The shearing method according to claim 5, wherein the moving inclination angle α of the finishing die that moves to be inclined is approximately 30° based on the vertical line.

7. The shearing method according to claim 4, wherein a material of the finishing die is SDK11.

8. The shearing method according to claim 4, wherein a load of the finishing die is in a range of approximately 15 kN to 22 kN.

9. The shearing method according to claim 4, wherein during the third step, a substantial portion of the fracture surface is transformed to a finished surface.
